(19) United States
(12) Patent Application Publication
(10) Pub. No.: US 2008/0105017 A1
(43) Pub. Date: May 8, 2008

(54) CYLINDER LOCK IMPROVEMENT TO PREVENT OPENING BY A BUMP KEY

(76) Inventor: Edward F. Owens, Ellicott City, MD (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/555,781

(22) Filed: Nov. 2, 2006

(51) Int. Cl. E05B 27/04

(52) U.S. Cl. 70/493

(57) ABSTRACT

A cylinder lock (10) includes a lock cylinder (12) having a central bore (14). A series of bores (16) extend orthogonally of the lock cylinder and open into the central bore. A barrel (18) fits into the central bore and has bores (20) therein corresponding to those in the lock cylinder and aligned therewith. A keyway (22) is for insertion of a key (24) into the barrel. A tumbler pin (26) fits into each bore and extends through the bore in the cylinder lock into the corresponding bore in the barrel. Insertion of an appropriate key into the keyway move the tumbler pins out of the bores in the barrel and into the bores in the cylinder lock, so turning of the key rotates the barrel with respect to the lock cylinder and opens the lock. An improvement of the invention includes a blocking pin (30) inserted into each of the bores to relocate the gap (G) created in the bore when a bump key (28) is struck after being inserted into the keyway. Relocating this gap causes the tumbler pin to not clear the bore in the barrel when the bump key is struck after being inserted into the keyway, and prevents turning of the bump key from rotating the barrel and opening the lock.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

This invention relates to cylinder type locks and keys used with such locks. More particularly, the present invention is directed to an improvement to a cylinder lock to prevent the lock from being readily opened by a “bump” key.

Key bumping is a technique by which a key that is cut or filed to the lowest normal configuration known in the lock industry as a 99999 key can be used to readily open a standard cylinder lock. When the modified 99999 key is struck and caused to enter the lock slightly further than the standard key, each pin is contacted by the key and the momentum of the bump key causes the upper most pin to jump and create a gap between it and the other pin or pins. During the split second while the gap exists between the upper pin and the lower pin the lock can be rotated. In fact, most cylinder locks can be easily opened using such a key that has been appropriately modified so that there is no need for a lock pick to open a lock and gain illegal entry to a premises. While use of bump keys are supposed to be highly restricted with various websites, for example, offering to sell them only to professional locksmiths, other websites offer instructional videos showing anyone downloading them how to make their own bump key.

The present invention is directed to an improvement to a cylinder lock which, when incorporated either into a new lock, or retrofitted into an existing lock, prevents a bump key from opening the lock.

### BRIEF SUMMARY OF THE INVENTION

The present invention is directed to an improvement in a cylinder lock to prevent a bump key from opening the lock. A cylinder lock and a barrel received in a central opening in the cylinder lock each have a series of aligned bores in which tumbler pins are inserted. The tumbler pins are movable by insertion of a key into the lock. If the tumbler pins are moved out of the bores in the barrel by the key, the key can then rotate the barrel about a lock cylinder and open the lock. The improvement of the present invention includes inserting an upper blocking pin into each bore in the lock cylinder. Insertion of the blocking pin provides a pin above the lock barrel so that when the lock is bumped with a bump key the gap created by the momentum is above the barrel and the bump key cannot turn the barrel and open the lock. Normal operation of the lock by the proper key is not effected by the improvement.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a sectional view of a cylinder lock illustrating the lock with a low cut 99999 key inserted;

FIG. 2 is a view similar to FIG. 1 and illustrating where material is removed from the standard key to convert the key into a “bump” key;

FIG. 3 is a view similar to FIG. 1 illustrating how striking the bump causes the pins to jump and allow the operation of the bump key to open the lock;

FIG. 4 is a sectional view of a cylinder lock illustrating the improvement of the present invention; and,

FIG. 5 is a view similar to FIG. 4 illustrating how the improvement prevents operation of a bump key from opening the lock.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

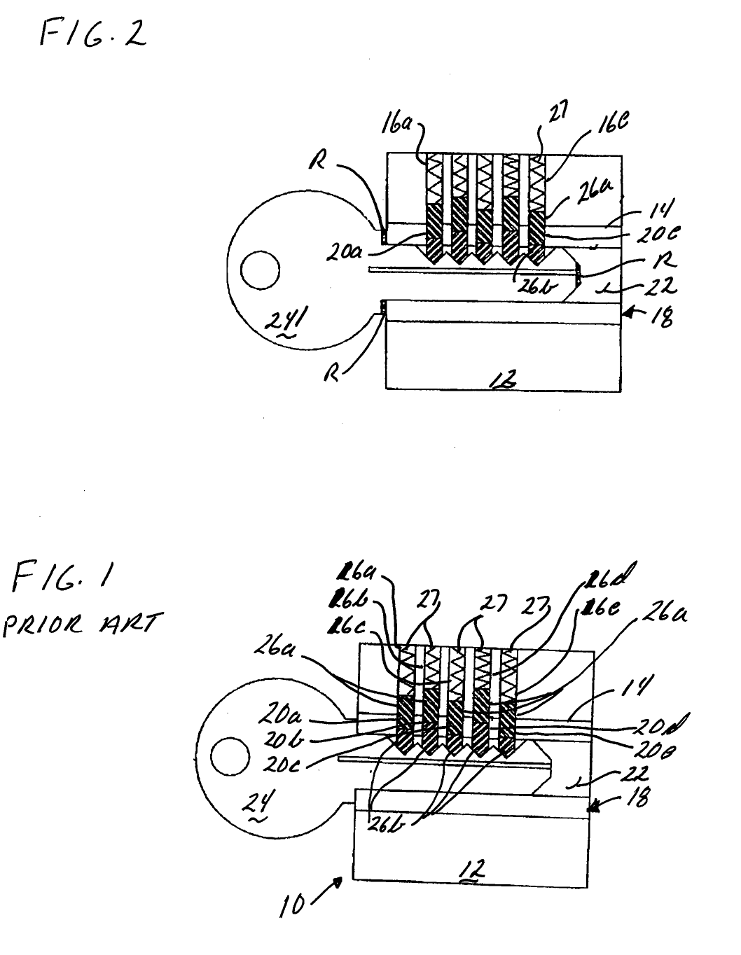

Referring to FIG. 1, a cylinder lock 10 includes a lock cylinder 12. The lock cylinder has a central bore 14 extending the length of the cylinder lock. A series of bores 16a-16n are formed in the lock cylinder. These bores extend orthogonally of the lock cylinder, perpendicular to a longitudinal center line of the lock cylinder, with the outer ends of each bore 16 opening into central bore 14.

A barrel 18 fits into the central bore of lock cylinder 12 and the barrel has bores 20a-20n therein which correspond in diameter to the bores 16 in the lock cylinder. However, the length of the bores 16 is greater than that of the bores 20. Each bore 20 in barrel 18 is aligned with a corresponding bore 16 in lock cylinder 12. Barrel 18 further includes a keyway 22 for insertion of a key 24 into the barrel. A tumbler pin 26a is sized to fit into each bore and extend through a bore 16 in cylinder lock 12 into a corresponding bore 20 in barrel 18. Respective springs 27 at the inner end of each bore 16 in lock cylinder 12 urge the tumbler pin 26a fitted in that bore into the corresponding bore 20 in barrel 18. The tumbler pins 26a are cylindrical in shape and uniform in length, with the length of the tumbler pins being greater than the length of the bores 20 in barrel 18. A tumbler pin 26b is also sized to fit into the bores 20 of barrel 18. These pins are also cylindrical in shape with an inner end of each pin being beveled to produce a tip which is contacted by a key inserted into the lock.

When no key, or the wrong key, is inserted into keyway 22, at least one of the tumbler pins 26a bridges the interface between a bore 20 in barrel 18 and the corresponding bore 16 in lock cylinder 12. This prevents the barrel from turning in cylinder lock 10 and keeps the lock from opening. However, insertion of an appropriate key 24 into keyway 22 elevates the tumbler pins 26a completely out of the bores 20 in the barrel and into the bores 16 in the cylinder lock. Now, turning of the key rotates the barrel with respect to the lock cylinder and opens the lock.

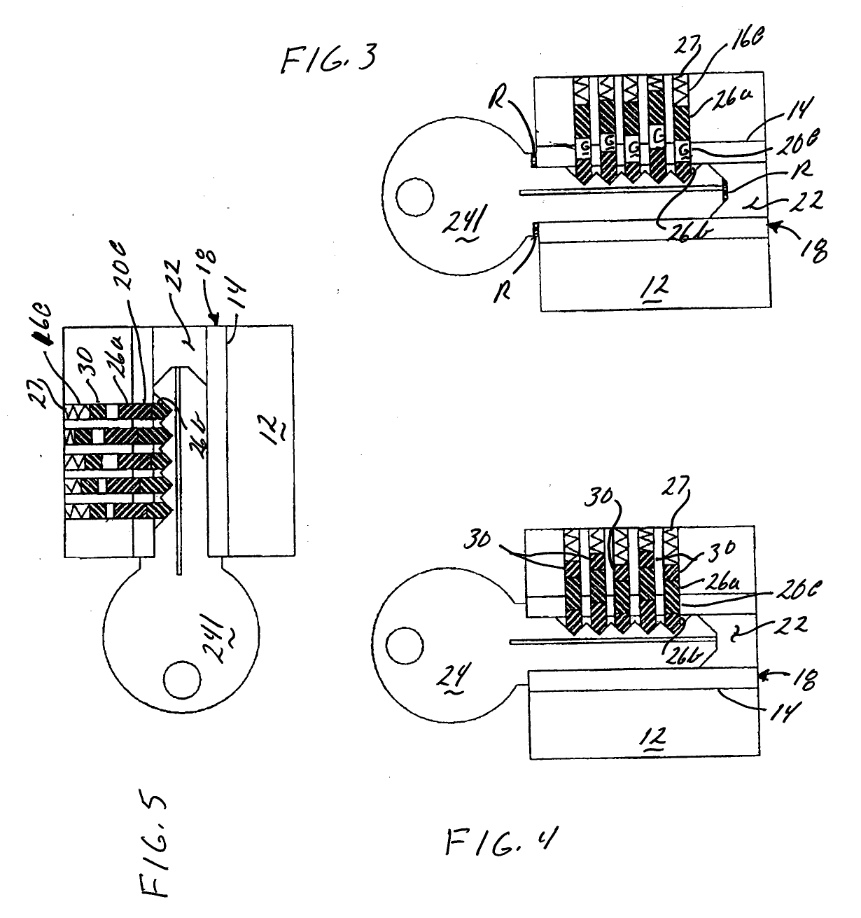

As shown in FIGS. 2 and 3, and as known in the art, a “bump” key 241 is made by taking a low cut key 24 such as a 99999 key and removing portions of the key, as indicated by the cross-hatched areas. One place where material is removed is in the area on each side of the head of the key, where the head of the key and key shank meet. The other area is at the distal end of the shank. This latter is done so that the overall length of the shank of the bump key is the same as that as of the shank of the original, unaltered key. Now, when the resultant bump key 241 is inserted into keyway 22 and struck with a quick blow, the bump action produced by the key lifts the tumbler pins 26a completely out of their bores 20 in barrel 18. The result is a momentary gap G or clearance formed between the tumbler pins and the bores 20 before the springs 27 urge the tumbler pins 26a back into place. Just as with insertion of an appropriate key 24 into the lock, while the gaps G exist, barrel 18 can now be turned to open the lock.

An improvement of the present invention includes fitting a blocking pin 30 into at least one, and preferably each of the bores 16 in lock cylinder 12. The blocking pins 30 are uniform in size and shape and sized to fit into the bores as shown in FIG. 4. The pins can be inserted into the lock cylinder during initial fabrication of lock 10, or the lock can be retrofitted to include the pins 30. Retrofitting the lock involves removing the barrel and tumbler pins from the lock cylinder, inserting a blocking pin into each bore in the lock cylinder, and then reassembling the barrel and tumbler pins into the lock cylinder. The blocking pins 30 are installed in the bores 16 inwardly of the tumbler pins 26a so that one end of a respective spring 27 bears against one end of a pin 30. The other end of pin 30 contacts and bears against the inner end of the tumbler pin 26a inserted in the bore.

As shown in FIG. 5, the purpose of the blocking pins 30 is to provide a pin above the barrel so that when a bump key is struck and causes a gap between pins, the gap will be above the barrel bore and cause the tumbler pins 26a to not clear the bore 20 in barrel 18 in which the tumbler pin is installed when a bump key 241 is hit after being inserted into keyway 22. Rather, tumbler pins continue to bridge across the barrel and lock cylinder, and this prevents the bump key from rotating the barrel and opening the lock when someone tries to turn the key. Accordingly, cylinder lock 10 cannot now be readily opened by someone not having the correct key 24 and trying to open the lock with a bump key 241 instead. Importantly, insertion of the blocking pins into the bores does effect normal operation of the lock when someone tries to open it with the correct key.

In view of the above, it will be seen that the several objects and advantages of the present disclosure have been achieved and other advantageous results have been obtained.

1. In a cylinder lock comprising a lock cylinder having a central bore extending longitudinally through the cylinder and bores extending orthogonally of the lock cylinder and opening into the central bore, a barrel fitting into the central bore and having bores therein corresponding to those in the lock cylinder and aligned therewith and a keyway for insertion of a key into the barrel, and a tumbler pin fitting into each of the bores and extending through the bore in the cylinder lock into the corresponding bore in the barrel for insertion of an appropriate key into the keyway to lift the tumbler pins out of the bores in the barrel into the bores in the cylinder lock so turning of the key will rotate the barrel with respect to the lock cylinder opening the lock, an improvement comprising a unitary blocking pin inserted into one of the bores to cause the gap created in the bore when a bump key is struck after being inserted into the keyway to be above the lock barrel, causing the tumbler pin to not clear the bore in the barrel when the bump key is struck after being inserted into the keyway, thereby preventing turning of the bump key from rotating the barrel and opening the lock.

2. The improvement of claim 1 further including a blocking pin inserted into each of the bores.

3. The improvement of claim 2 in which a spring is fitted into each bore in the cylinder lock, the spring urging the tumbler pin inserted in that bore into the corresponding bore in the barrel, and the improvement includes insertion of the blocking pin between the spring and tumbler pin of each bore.

4. The improvement of claim 2 in which the blocking pins is of a uniform size and shape.

5. The improvement of claim 2 in which the blocking pins are inserted into each bore of the lock cylinder during initial manufacture of the cylinder lock.

6. The improvement of claim 2 in which the cylinder lock is retrofitted by removing the spring from the barrel and inserting a blocking pin into each bore in the lock cylinder, and then reassembling the cylinder lock.

7. In a cylinder lock comprising a lock cylinder having a central bore extending longitudinally through the cylinder and bores extending orthogonally of the lock cylinder and opening into the central bore, a barrel fitting into the central bore and having bores therein corresponding to those in the lock cylinder and aligned therewith and a keyway for insertion of a key into the barrel, and a tumbler pin fitting into each of the bores and extending through the bore in the cylinder lock into the corresponding bore in the barrel for insertion of an appropriate key into the keyway to move the tumbler pins out of the bores in the barrel into the bores in the cylinder lock so turning of the key will rotate the barrel with respect to the lock cylinder opening the lock, an method for preventing opening of the cylinder lock by a bump key comprising fitting a unitary blocking pin into one of the bores to relocate the gap created in the bore when a bump key is struck after being inserted into the keyway, relocation of the gap causing the tumbler pin to not clear the bore in the barrel when the bump key is struck after being inserted into the keyway, thereby preventing turning of the bump key from rotating the barrel and opening the lock.

8. The method of claim 7 further including inserting a blocking pin into each of the bores.

9. The method of claim 8 in which a spring is fitted into each bore in the cylinder lock, the spring urging the tumbler pin inserted in that bore into the corresponding bore in the barrel, and the method includes inserting the blocking pin between the spring and the tumbler pin.

10. The method of claim 8 including inserting the blocking pins into each bore of the lock cylinder during initial manufacture of the cylinder lock.

11. The method of claim 8 including retrofitting a cylinder lock by removing the barrel and tumbler pins from the lock cylinder, inserting a blocking pin into each bore in the lock cylinder, and then reassembling the barrel and tumbler pins into the lock cylinder.
